(19) United States
(12) Patent Application Publication
(10) Pub. No.: US 2017/0334042 A1
(43) Pub. Date: Nov. 23, 2017

(54) CLIP FOR SEWING

(71) Applicant: CLOVER MFG. CO., LTD., Osaka (JP)

(72) Inventor: Chihiro IWASAKI, Osaka (JP)

(21) Appl. No.: 15/584,801

(22) Filed: May 2, 2017

(30) Foreign Application Priority Data
May 19, 2016 (JP) 2016-100453

(51) Int. Cl. B25B 5/16; A44B 99/00

(52) U.S. Cl. CPC B25B 5/163; A44B 99/00

(57) ABSTRACT

A clip for sewing includes lower and upper members that are pivotable to each other about a given axis. The lower member has a first prong portion and a first handling portion opposite to the first prong portion. The upper member has a second prong portion and a second handling portion opposite to the second prong portion. A bias member urges the lower and the upper members about the axis so that the first prong portion and the second prong portion are drawn to each other to shut. A plurality of projection/recess pairs are provided, each pair having ng a recess and a corresponding projection to be received in the recess. In each of the projection/recess pairs, the recess is provided at one of the first and second prong portions, while the corresponding projection is provided at the other of them.

### FIELD

The present disclosure relates to clips for use in sewing and other handicraft activities to temporarily hold fabric or similar material.

### BACKGROUND

Clips are commonly used in offices for example, and a variety of clips are now available. For instance, one type of such clips has a pair of handling portions at one end and a pair of prong portions opposite to the handling portions. The prong portions are urged toward each other by a bias force of a spring for example, so that an object (such as sheets of paper) can be gripped between the paired prong portions.

There are other types of clips designed for sewing, and these sewing clips are also configured to temporarily hold an object (such as a sheet of fabric or other material) between paired prong portions under a biasing force.

Specifically, sewing clips may be used to temporarily hold together a folded portion of fabric to make the sewing work easier. Typically, a number of clips are used to be positioned at intervals along the folded portion. To facilitate the sewing by using many clips at the same time, individual clips may preferably be small in size and weight, and still capable of firmly gripping the fabric.

### SUMMARY

The present disclosure, made in view of the above, provides a clip for sewing that can be readily attached to fabric or other material even in proximity to another clip.

According to an aspect of the present disclosure, there is provided a clip for sewing, which may include: a lower member provided with a first prong portion and a first handling portion; an upper member provided with a second prong portion and a second handling portion, and configured to be pivotable relative to the lower member about an axis; a bias member that urges the first prong portion and the second prong portion toward each other; and a plurality of projection/recess pairs each including a recess and a corresponding projection received in the recess. In each of the projection/recess pairs, the recess may be provided at one of the first prong portion and the second prong portion, while the corresponding projection may be provided at the other of the first prong portion and the second prong portion.

Preferably, the plurality of projection/recess pairs may include four projection/recess pairs disposed at four apexes of a quadrilateral, respectively.

Preferably, the first prong portion and the second prong portion may have a first width measured in a direction parallel to the axis, and the first handling portion and the second handling portion may have a second width measured in said direction, where the first width is smaller than the second width.

Preferably, the first width may be 60% or less of the second width.

Preferably, the plurality of projection/recess pairs may be disposed at a density of 0.2 to 1.0 pairs/mm².

Preferably, the plurality of projection/recess pairs may include a first pair and a second pair, and both the recess of the first pair and the projection of the second pair may be provided at the first prong portion.

Preferably, the recess of the first pair and the projection of the second pair may be spaced apart from each other in a direction parallel to the axis.

Preferably, the recess of the first pair and the projection of the second pair may be spaced apart from each other in a direction perpendicular to the axis.

Preferably, the lower member may have a flat lower surface, and the first prong portion and the second prong portion may have a first face and a second face, respectively, where the first face and the second face are arranged to face each other and are parallel to the lower surface of the lower member.

Preferably, the lower member may have an upper surface provided with a plurality of markings spaced from each other in a direction perpendicular to the axis.

Preferably, the lower member may be transparent.

Other features and advantages of the clip will become more apparent from the detailed description given below.

### BRIEF DESCRIPTION OF THE DRAWINGS

FIG. 1 is a side view of a sewing clip according to the present disclosure.

FIG. 2 is a plan view of the sewing clip shown in FIG. 1.

FIG. 3 is a sectional view taken along line of FIG. 1.

FIG. 4 is a sectional view taken along line IV-IV of FIG. 2.

FIG. 5 is a sectional view similar to FIG. 4, except that a first prong portion and a second prong portion are open.

FIG. 6 is a sectional view taken along line VI-VI of FIG. 2.

FIG. 7 is a sectional view taken along line VII-VII of FIG. 2.

FIG. 8 is a plan view showing a portion of a lower member.

FIG. 9 is a plan view showing a portion of a lower member.

FIG. 10 is a view illustrating a use of sewing clips shown in FIG. 1.

FIG. 11 is a view illustrating a user of sewing clips shown in FIG. 1.

### DESCRIPTION OF THE PREFERRED EMBODIMENTS

The following describes preferred embodiments in accordance with the present disclosure referring to the accompanying drawings.

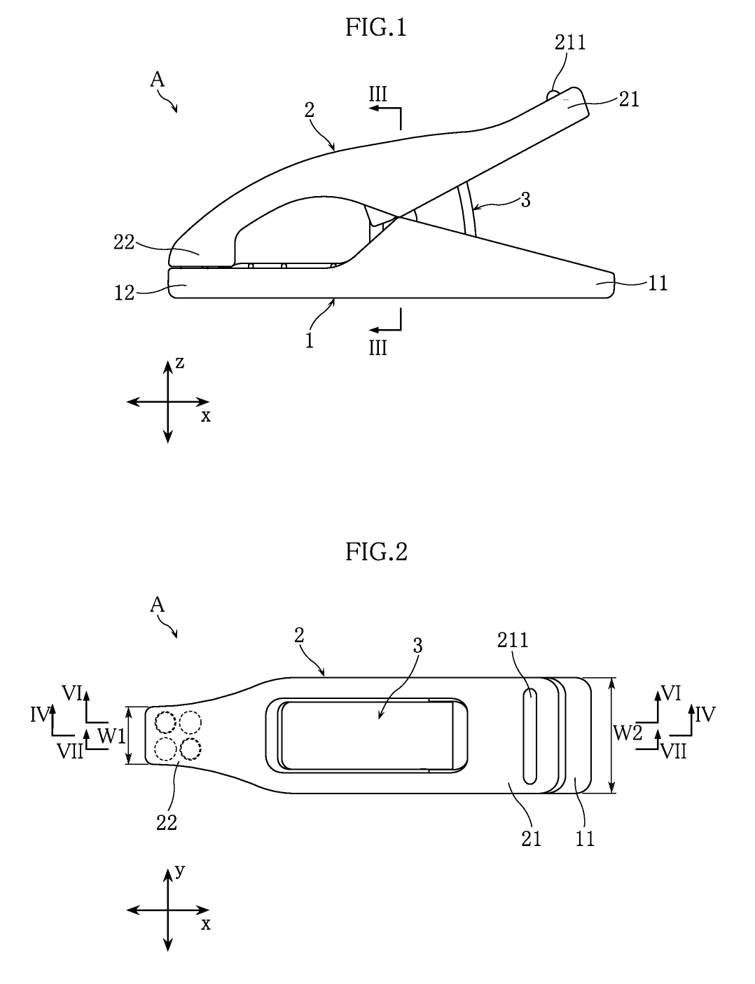

FIGS. 1 to 8 show an embodiment of a sewing clip according to the present disclosure. The sewing clip A is usable to temporarily fasten together an object (such as layers of fabric or other material) in sewing and other handicraft activities. The sewing clip A includes a lower member 1, an upper member 2 and a bias member 3, for example.

The lower member 1 is elongated in x direction, including one end at a base of the sewing clip and another end at a tip of the sewing clip. The base-side end provides a first handling portion 11, whereas the tip-side end provides a first prong portion 12. The lower member 1 has a length L1 of about 25 to 30 mm in the x direction.

The upper member 2 has a base-side end providing a second handling portion 21 and a tip-side end providing a second prong portion 22. The second handling portion 21 is located opposite the first handling portion 11 in z direction perpendicular to the x direction. Similarly, the second prong portion 22 is located opposite the first prong portion 12 in the z direction.

The first handling portion 11 and the second handling portion 21 are manually operated by a user. The second handling portion 21 is provided with a ridge 211 extending in y direction (width direction) perpendicular to both the x and z directions.

The first prong portion 12 and the second prong portion 22 grip an object between them by a biasing force of the bias member 3, as described below in more detail. The first prong portion 12 and the second prong portion 22 have a width W1 (first dimension) measured in the y direction, whereas the first handling portion 11 and the second handling portion 21 have a width W2 (second dimension) measured in the y direction, with the width W1 being smaller than the width W2. Specifically, the width W1 of the first prong portion 12 and the second prong portion 22 may be 60% of or less than (more preferably, 50% of or less than) the width W2 of the first handling portion 11 and the second handling portion 21. In one specific example, the width W1 may be about 3.5 mm, and the width W2 may be about 7.0 mm.

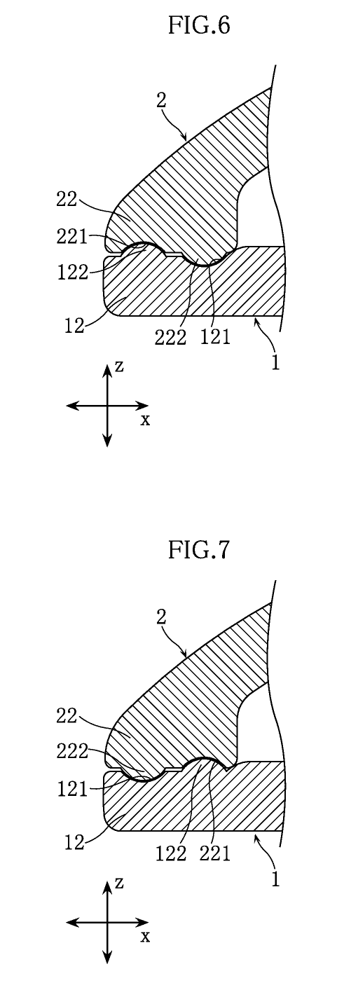

As shown in FIGS. 6 and 7, the first prong portion 12 may have a plurality of recesses 121 and a plurality of projections 122. Also, the second prong portion 22 may have a plurality of recesses 221 and a plurality of projections 222. The details of the recesses 121 and 221 and the projections 122 and 222 will be described below.

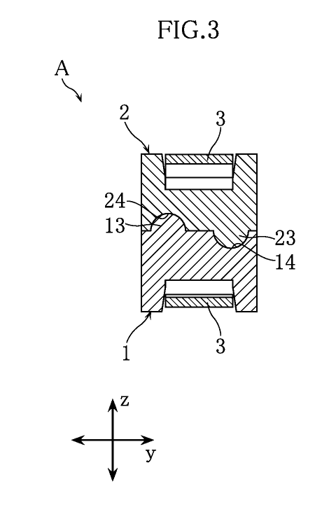

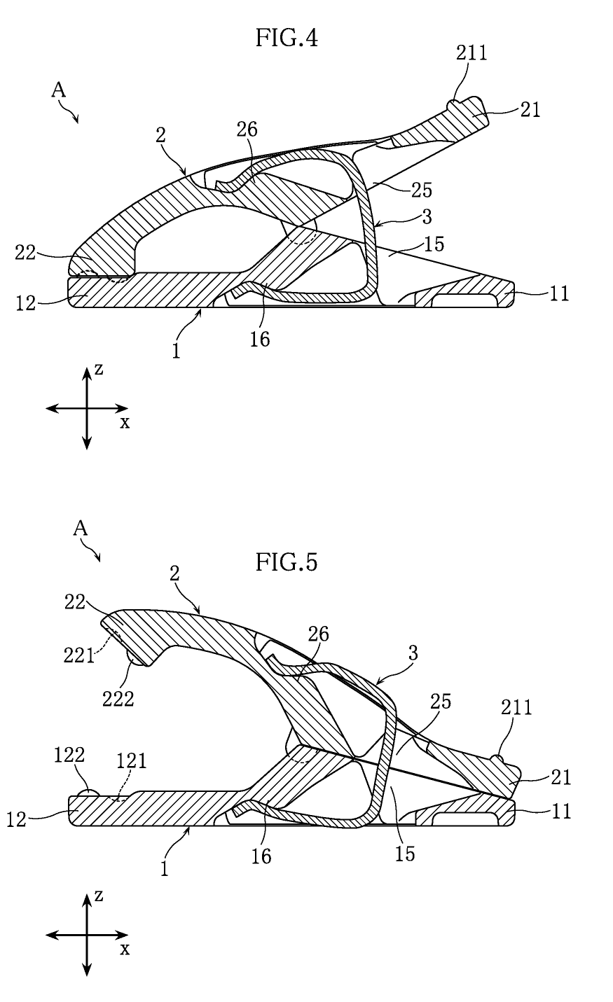

As shown in FIG. 3 (and also in view of FIG. 4), the lower member 1 is formed with a protuberance 13 and a hollow 14, next to each other, that are disposed at a longitudinally central location of the lower member 1 in the y direction. The protuberance 13 and the hollow 14 have a hemispherical shape and face the upper member 2. Similarly, the upper member 2 is formed with a protuberance 23 and a hollow 24, next to each other, disposed at a longitudinally central location of the upper member 2 in the y direction. The protuberance 23 and the hollow 24 have a hemispherical shape and face the lower member 1. The protuberance 13 of the lower member 1 is received in the hollow 24 of the upper member 2, whereas the protuberance 23 of the upper member 2 is received in the hollow 14 of the lower member 1.

Each of the lower member 1 and the upper member 2 may be an integral, single-piece member made from a colorless transparent, or colored transparent, or semi-transparent resin material. Examples of such a resin material include polycarbonate. In the present embodiment, the lower member 1 is fully transparent (i.e., with no color), whereas the upper member 2 is colored but still can be seen through.

The bias member 3 may be a metal leaf spring that interlocks the lower member 1 and the upper member 2 to each other. More specifically, as shown in FIGS. 4 and 5, the bias member 3 extends through an opening 15 in the lower member 1 and an opening 25 in the upper member 2 to define a U-like cross section, with one end anchored to a concaved portion 16 of the lower member 1 and the other end to a concaved portion 26 of the upper member 2.

The bias member 3 may be a single, resilient piece for applying a biasing force to urge the first prong portion 12 and the second prong portion 22 toward each other, thereby drawing the two portions 12, 22 shut. FIG. 4 shows a closed state in which the first prong portion 12 and the second prong portion 22 are in contact or substantially in contact with each other. In the state shown in FIG. 4, the first handling portion 11 and the second handling portion 21 are a predetermined distance away from each other. FIG. 5 shows an open state in which the first prong portion 12 and the second prong portion 22 are open as a result that the first handling portion 11 and the second handling portion 21 are moved toward each other until the two handling portions 11, 21 abut against each other. The bias force applied by the bias member 3 on the prong portions 12 and 22 in the state of FIG. 5 is greater than in the state of FIG. 4.

As seen from FIGS. 4 and 5, the lower member 1 and the upper member 2 are urged toward each other by the bias member 3. In addition, as described above referring to FIG. 3, the hollow 14 of the lower member 1 receives the protuberance 23 of the upper member 2, and the hollow 24 of the upper member 2 receives the protuberance 13 of the lower member 1. This engagement enables the lower member 1 and the upper member 2 to pivot relative to each other about an axis extending in the y direction, reciprocating between the state shown in FIG. 4 (closed state) and the state shown in FIG. 5 (open state).

As shown in FIGS. 6 and 7, in the closed state, the recesses 121 of the first prong portion 12 receive the projection 222 of the second prong portion 22, respectively (i.e., one to one relation), and the recesses 221 of the second prong portion 22 receive the projections 122 of the first prong portion 12, respectively. In this manner, the recesses 121, 221 and the projections 122, 222 form projection/recess pairs. Specifically, each recess 121 is paired with one of the projections 222, and each recess 221 is paired with one of the projections 122. The recesses 121, 122 and the projections 122, 222 all have a generally hemispherical shape with a substantially equal radius.

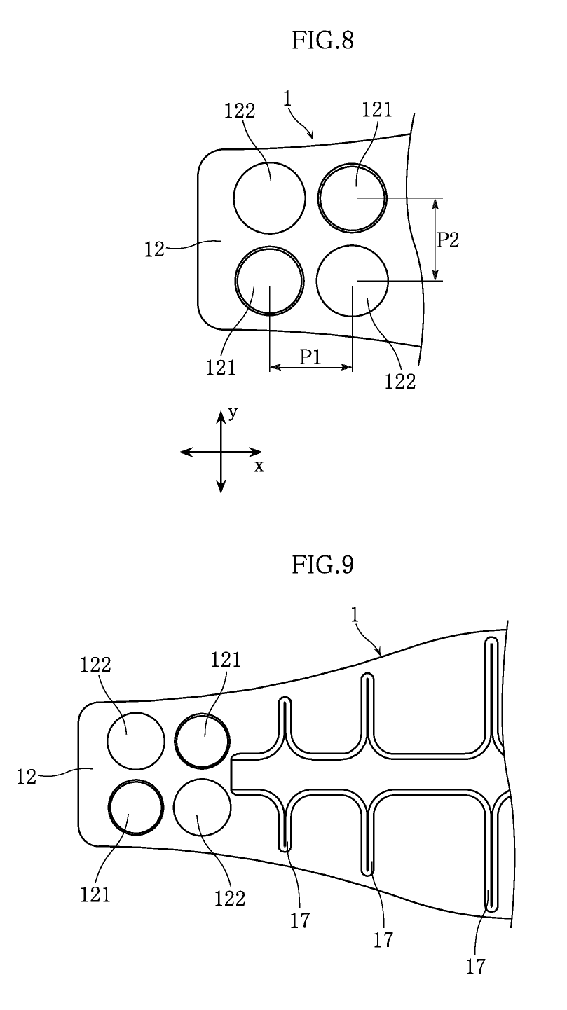

The above-mentioned projection/recess pairs may be provided such that two or more pairs are arrayed in the x direction and two or more pairs are arrayed in the y direction. As described below, in an example shown in FIG. 8, without limitation, two pairs are arranged in both the x direction and the y direction, and hence four pairs in total are disposed at four apexes of a quadrilateral (including a square, a rectangular, and so on).

FIG. 8 is a plan view of the first prong portion 12. As seen from the figure, the first prong portion 12 has two recesses 121 and two projections 122 alternately arranged in the x and y directions. The recesses 121 and the projections 122 are arranged at a predetermined spacing in the x and y directions. The projection/recess pairs are provided to meet a predetermined number density (the number of pairs per unit area), for example, a density of 0.2 to 1.0 pairs per an area of 1 mm². In one specific example, the spacing P1 between a recess 121 and a projection 122 in the x direction, as well as the spacing P2 in the y direction, is 1.6 mm. Thus, in this example, a total of one projection/recess pair (i.e., 4×a quarter of pair) is provided in an area of 1.6×1.6 mm², and thus the density is approximately 0.39 pairs/mm².

FIG. 9 is a plan view showing the first prong portion 12 of the lower member 1, along with a nearby portion. As shown in the figure, the top face of the lower member 1 is provided with markings 17 each of which may indicate a distance from the tip of the first prong portion 12. According to the present embodiment, the markings 17 are provided at 5 mm, 7 mm and 10 mm away from the tip of the first prong portion 12. Each marking 17 may be an upwardly projecting ridge on the upper surface. When the lower member 1 is transparent, the markings 17 can be seen from the back side of the sewing clip A with an object sandwiched between the lower and upper members 1, 2. This is helpful to place or adjust the sewing clip A relative to the sandwiched object at a desired depth from the peripheral edge of the object.

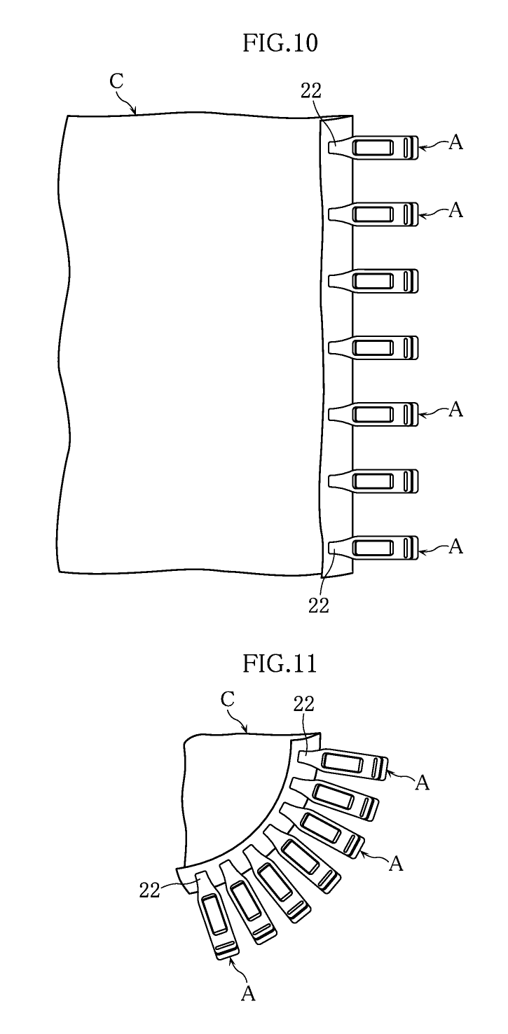

With reference to FIGS. 10 and 11, the following describes uses and advantages of the sewing clip A having the above-described configuration.

The sewing clip A according to the present embodiment may be used to temporarily hold fabric in the following manner. FIG. 10 shows a multiplicity of sewing clips A in use. In the figure, a section of fabric C folded to provide a seam allowance is temporarily held together by the sewing clips A. To this end, the folded section of the fabric C is clamped between the first prong portion 12 and the second prong portion 22 of each sewing clip A.

As described above, the first prong portion 12 and the second prong portion 22 of each sewing clip A are provided with the recesses 121, 221 and the projections 122, 222 (forming projection/recess pairs) arrayed in the x and the y directions. With these pairs, the first prong portion 12 and the second prong portion 22 can firmly grip the object so as not to let the object slip easily in the x or y direction. Advantageously, the sewing clip A of this example can produce a sufficient gripping force even when it is relatively small in size.

In addition, the width W1 of the first and second prong portions 12, 22 is smaller than the width W2 of the first and second handling portions 11, 21. In one example, the width W1 is 60% or less of the width W2. Having the first and second prong portions 12, 22 with such a small width W1, each sewing clip A can grip a narrow or limited region of fabric C with a sufficient gripping force. In addition, due to the small width W1, a number of sewing clips A can be attached densely along a curved edge, as shown in FIG. 11, without interfering with the adjacent clips.

Further, the first prong portion 12 has a plurality of recesses 121 and a plurality of projections 122 that are alternately arranged in the x and y directions. With this configuration, the sandwiched object ripples between the first prong portion 12 and the second prong portion 22, with some portions pushed upward and some portions pushed downward, as seen from FIGS. 6 and 7. In this manner, the object can be held firmly so as not to slip in any directions including the x and the y directions.

Although specific embodiments of the present disclosure have been described, the present disclosure is not limited thereto, and various modifications may be made without departing from the spirit of the present disclosure. In addition, the specific geometry and materials of the constituting parts of the sewing clip described in the above embodiment should not be taken as limitation.

In the above embodiment, the projection/recess pairs are provided such that two pairs arrayed in the x direction and two pairs in the y direction. However, the number and the arrangement of the projection/recess pairs are not so limited. In addition, according to the embodiment described above, each of the first and second prong portions 12, 22 has both recesses and projections. In an alternative example, one of the first and second prong portions 12, 22 may be provided with recesses only, whereas the other with projections only.

According to the embodiment described above, the lower member 1 and the upper member 2 are pivotably engaged with each other about a given axis, with the protuberances 13 and 23 being removably received in the hollows 24 and 14, respectively. In an alternative example, the lower member 1 and the upper member 2 may be coupled to each other in a semi-permanent manner so that the two members cannot be readily detached from each other. For example, use may be made of a thin, slid shaft that pierces through the upper and lower members 1, 2 in a manner such that the two members 1, 2 can pivot relative to each other about the shaft.

1. A clip for sewing, comprising:
a lower member comprising a first prong portion and a first handling portion;
an upper member comprising a second prong portion and a second handling portion, the upper member being pivotable relative to the lower member about an axis;
a bias member that urges the first prong portion and the second prong portion toward each other; and
a plurality of projection/recess pairs each comprising a recess and a corresponding projection received in the recess,
wherein in each of the projection/recess pairs, the recess is provided at one of the first prong portion and the second prong portion, and the corresponding projection is provided at the other of the first prong portion and the second prong portion.

2. The clip according to claim 1, wherein the plurality of projection/recess pairs comprise four projection/recess pairs disposed at four apexes of a quadrilateral, respectively.

3. The clip according to claim 1, wherein the first prong portion and the second prong portion have a first width measured in a direction parallel to the axis, the first handling portion and the second handling portion have a second width measured in said direction, and the first width is smaller than the second width.

4. The clip according to claim 3, wherein the first width is 60% or less of the second width.

5. The clip according to claim 1, wherein the plurality of projection/recess pairs are disposed at a density of 0.2 to 1.0 pairs/mm².

6. The clip according to claim 1, wherein the plurality of projection/recess pairs include a first pair and a second pair, and both the recess of the first pair and the projection of the second pair are provided at the first prong portion.

7. The clip according to claim 6, wherein the recess of the first pair and the projection of the second pair are spaced apart from each other in a direction parallel to the axis.

8. The clip according to claim 6, wherein the recess of the first pair and the projection of the second pair are spaced apart from each other in a direction perpendicular to the axis.

9. The clip according to claim 1, wherein the lower member comprises a flat lower surface, and the first prong portion and the second prong portion comprise a first face and a second face, respectively, that face each other and are parallel to the lower surface of the lower member.

10. The clip according to claim 1, wherein the lower member comprises an upper surface provided with a plurality of markings spaced from each other in a direction perpendicular to the axis.

11. The clip according to claim 1, wherein the lower member is transparent.
